(19) United States
(12) Patent Application Publication
(10) Pub. No.: US 2013/0266505 A1
(43) Pub. Date: Oct. 10, 2013

(54) HYDROGEN GENERATION BY HYDROGENATED POLYSILANES FOR OPERATING FUEL CELLS

(71) Applicants: Christian Bauch, Muldenstein (DE); Rumen Deltschew, Leipzig (DE); Sven Holl, Gueckingen (DE); Gerd Lippold, Leipzig (DE); Javad Mohsseni, Bitterfeld-Wolfen (DE); Juergen Steinwandel, Uhldingen-Muehlhofen (DE); Agata Godula-Jopek, Taufkirchen (DE); Christian Wolff, Ottobrunn (DE)

(72) Inventors: Christian Bauch, Muldenstein (DE); Rumen Deltschew, Leipzig (DE); Sven Holl, Gueckingen (DE); Gerd Lippold, Leipzig (DE); Javad Mohsseni, Bitterfeld-Wolfen (DE); Juergen Steinwandel, Uhldingen-Muehlhofen (DE); Agata Godula-Jopek, Taufkirchen (DE); Christian Wolff, Ottobrunn (DE)

(73) Assignees: EADS Deutschland GmbH, Ottobrunn (DE); Spawnt Private S.à.r.l., Luxembourg (LU)

(21) Appl. No.: 13/811,521

(22) PCT Filed: Jul. 20, 2011
(86) PCT No.: PCT/EP2011/062466

§ 371 Date: Jun. 26, 2013

(30) Foreign Application Priority Data
Jul. 23, 2010 (DE) 10 2010 032 075.7

(51) Int. Cl. B64D 41/00

(52) U.S. Cl. CPC B64D 41/00
USPC 423/648.1; 422/162; 422/119

(57) ABSTRACT

A fuel cell supply device that generates hydrogen for fuel cells in an aircraft includes a reaction chamber which reacts hydrogenated polysilanes or mixtures thereof with water; a feed device that feeds at least one reactant into the reaction chamber; and a discharge device that leads hydrogen formed in the reaction to a fuel cell.

### RELATED APPLICATIONS

This is a §371 of International Application No. PCT/EP2011/062466, with an international filing date of Jul. 20, 2011 (WO 2012/010639 A1, published Jan. 26, 2012), which is based on German Patent Application No. 10 2010 032 075.7 filed Jul. 23, 2010, the subject matter of which is incorporated herein by reference.

### TECHNICAL FIELD

This disclosure relates to hydrogen generation in aircraft, particularly to a fuel cell supply device that generates hydrogen for fuel cells in an aircraft, the use of a fuel cell supply device in an aircraft, an aircraft with a fuel cell supply device and a method of producing hydrogen for fuel cells in an aircraft.

### BACKGROUND

Fuel cells are known to be an efficient technology for generating electric current. With fuel cells, using gaseous energy carriers such as hydrogen or vaporized liquid fuels, chemical energy can be converted into electrical energy directly by electrochemical means. If hydrogen-oxygen fuel cells are used, they can be employed to generate water as well as electricity.

Hydrogen itself is nontoxic and evaporates rapidly. Extreme cooling (−253° C.) is required to be able to store hydrogen in cryogenic tanks in liquid form. As hydrogen does not occur as a raw material in nature, hydrogen is mainly produced by chemical methods from hydrogen-containing compounds such as hydrocarbons. However, certain fuel cells such as, for example, polymer electrolyte (PEM: proton exchange membrane) fuel cells or alkaline fuel cells require hydrogen of very high purity. Even small amounts of other gases and other impurities in hydrogen impair the efficiency of the fuel cells. The necessary level of purity of process hydrogen gas is not achieved in the usual reforming processes using, for example, hydrocarbons or also alcohols. Therefore, in reforming processes of, for example, natural gas, considerable technical expense is required so that such a PEM fuel cell supply technology is in practice only suitable for stationary installations.

For use on board transport vehicles, for example, motor vehicles or aircraft, as described in DE 10 2005 051 583, fuel cells are known that contain a hydrogen gas electrode and operation, require a feed of hydrogen gas. A supply of hydrogen on board a mobile vehicle can be provided, for example, with classic storage means such as pressure vessels or cryogenic tanks. However, especially for aviation, use of classic storage devices such as cryogenic tanks or pressure vessels is limited both on the grounds of safety and for reasons of capacity. Furthermore, chemical converters are possible such as steam reforming, partial oxidation and autothermal reforming. However, the aforementioned chemical converters require auxiliary materials such as water or oxygen, or both. Furthermore, in particular, fuel cells of the PEM type need process hydrogen gas of high purity and therefore require, in addition to the reforming, other gas purification processes, for example, to remove carbon monoxide (CO).

Furthermore, a method is described in DE 100 59 625 for producing increasingly longer-chain and finally higher silanes which can be used as fuels that are not spontaneously flammable. According to WO2008/000241, through pyrolysis with exclusion of oxygen or air, silanes can be used as energy carriers both to purify silicon and supply hydrogen for the operation of fuel cells.

It could therefore be helpful to provide a simple and safe hydrogen supply for fuel cells in aircraft.

### SUMMARY

We provide a fuel cell supply device that generates hydrogen for fuel cells in an aircraft including a reaction chamber which reacts hydrogenated polysilanes or mixtures thereof with water; a feed device that feeds at least one reactant into the reaction chamber; and a discharge device that leads hydrogen formed in the reaction to a fuel cell.

We also provide a method of producing hydrogen for fuel cells in an aircraft including feeding at least one of a first and second reactant into a reaction chamber, wherein the first reactant includes hydrogenated polysilanes or mixtures thereof and the second reactant is water; reacting the first reactant with the second reactant in the reaction chamber; and leading the hydrogen formed in the reaction to a fuel cell of the aircraft

### BRIEF DESCRIPTION OF THE DRAWINGS

FIG. 1 shows a schematic view of a fuel cell supply device that generates hydrogen.

FIG. 2 shows another practical example of the fuel, cell supply device with a feed device that recycles water from the fuel cell and a waste heat recuperator.

FIG. 3 shows a two-dimensional schematic view of an aircraft with two practical examples.

FIG. 4 shows a schematic view of a method of fuel cell supply according to a practical example.

### DETAILED DESCRIPTION

We provide a fuel cell supply device, the use of a supply device in an aircraft, the use of a hydrogen supply device as emergency system, an aircraft with a supply device and a method of hydrogen supply for fuel cells.

According to one example, a fuel cell supply device generates hydrogen for fuel cells in an aircraft. The fuel cell supply device has a reaction chamber designed to react hydrogenated polysilane or mixtures thereof with water. Furthermore, a feed device feeds at least one reactant into the reaction chamber and a discharge device discharges the hydrogen that forms in the reaction from the reaction chamber, and feeds the hydrogen to a fuel cell.

In this way, the bound hydrogen in hydrogenated polysilanes can be split off for the operation of a fuel cell. Hydrogenated polysilane is a nontoxic substance consisting essentially of silicon and hydrogen. When hydrogen is produced from hydrogenated polysilane, with a corresponding level of purity, further purification is unnecessary so that it can, for example, be used directly in a PEM fuel cell.

The term “polysilanes” generally denotes compounds with the empirical formula SiₙH₂ₙ or SiₙH₂ₙ₊₂, where n is greater than six (n>6). “Hydrogenated polysilanes”, which are also designated hereinafter with the abbreviation “HPS,” are to be understood as polysilanes in solid form under standard conditions. Polysilanes are designated as in solid form, which are solid as the individual compound, or are solid in a mixture of several polysilanes.

Standard conditions are a pressure of one physical atmosphere (p=1 atm) and a temperature (standard temperature) of twenty degrees Celsius (T=20° C.). These hydrogenated polysilanes or HPS and mixtures thereof can be produced, for example, according to DE 2006 043 929 A1, wherein the Si chains or the Si backbone have a number of Si atoms in the molecule of n>10 or n>12. An HPS with Si chain lengths of at least eleven silicon atoms, in other words starting from undecasilane, is no longer pyrophoric and, for example, can be in the form of a yellowish-white, solid powder.

With the solid form of HPS, simple and safe handling of the hydrogen storage material is possible. HPS can be stored well and different packing densities can be achieved depending on how the material is formed (powder, pellets, granules, beads, cubes). In this way, HPS can be stored in solid form and only dispersed in a liquid for transfer to the reaction chamber or can be mobilized with a solvent. Moreover, there is the possibility of feeding the HPS into the reaction chamber directly with a corresponding solid feeder,

The HPS storage device can be transported as a permanent hydrogen carrier essentially safely to various locations and/or can be stored there, and after transfer into the reaction chamber can produce hydrogen as required. The hydrogen produced by reaction of HPS with water can then be converted with efficient fuel cell systems into electrical energy. Moreover, handling and storage of the solid HPS are simple and safe. After addition of a basic reactant, preferably alkaline reactant, carrying out the reaction requires only a single reaction step to produce hydrogen. Addition of bases can be omitted if the content of base of the reaction vessel itself can catalyze the reaction sufficiently. During reaction of HPS with water in the presence of alkalis, soluble silicic acid Si(OH)₄ or colloidal polysilicic acids may form, which are also harmless.

HPS is thus an efficient hydrogen carrier which can be transported loss-free and stored relatively safely. Compared to elemental silicon, HPS is more suitable as a hydrogen carrier as more hydrogen can be released relative to the educt mass. With a hydrogen release of approx. 20 wt % relative to the HPS used, hydrogenated polysilane is suitable as a hydrogen supplier both for stationary and mobile uses. Owing, to the high purity of the hydrogen produced by HPS and water, this manner of hydrogen storage is suitable in particular in combination with low-temperature and/or high-temperature PEM fuel cells.

A supply device may be provided wherein the hydrogenated polysilane is in the form of a solid structure selected from the group consisting of powder, granules, pellets, beads, cubes and porous pieces.

The HPS can thus be stored safely and simply and can then be introduced via a feed device into the reaction chamber. A sealable opening can be used to add more, for example, pulverulent HPS. If HPS comes in contact with, for example, an alkaline aqueous solution, the HPS reacts with water and hydrogen is formed as a product. In this way, hydrogen can be produced in a single reaction step. On reaction of HPS with the basic aqueous solution, heat is generated, which in turn can be utilized by conveying the waste heat in a heat exchanger.

If the HPS is dispersed in an alkaline aqueous solution, for example, as powder, the reaction can take place uniformly distributed in the reaction chamber, if a mixing device such as a stirrer or a recirculating pump brings about homogeneous mixing in the reaction chamber. Alternatively a false bottom can be provided, on which larger pellets or porous pieces of HPS are collected. The feed device that feeds at least water is arranged at the level of the false bottom or above it by a spraying nozzle device to ensure contact of the HPS with the water. The hydrogen gas produced in the reaction chamber can be led via a discharge device for gas, which is preferably arranged on the top of the reaction chamber, directly to a fuel cell or combination of fuel cells.

A supply device may be provided wherein the reaction chamber provides a basic, especially an alkaline, medium.

In this way, production of hydrogen can be carried out and accelerated. The basicity of the water reacting with the FIRS is set in the pH range of 7 to 14 and can he adjusted, for example, by adding sodium hydroxide solution NaOH or potassium hydroxide solution KOH. The bases or alkalis can act catalytically on hydrolysis of the HPS. When amounts of alkali above stoichiometric are used, rapid and complete reaction can be ensured without volatile spontaneously flammable slimes forming temporarily. In the reaction chamber, in an aqueous solution with pH above 7, on decomposition of the polysilanes there is formation of hydrogen H₂ and silicate compounds such as, for example, water glass, as shown in the following reaction equation simplified for the empirical conditions, for example, for the reaction of polysilanes with the empirical formula SiₙH₂ₙ in alkaline medium (pH>7, amount of alkali above stoichiometric):

SiH₂+2 NaOH+H₂O→Na₂SiO₃+3 H₂.

The basic or alkaline aqueous solution can on the one hand already be prepared outside of the reaction chamber by adding a base or alkali to the feed water, which is then supplied via the feed device into the reaction chamber. On the other hand, a base or alkali or lye may only be supplied in the reaction chamber, for example, by another feed device and connected storage tank for bases, alkalis and lyes, then producing an aqueous alkaline solution and ideal reaction conditions in the reaction chamber. In this way, not only is reactivity of the HPS increased, but also solubility of the silicic acid products formed in the reaction is improved. For example, dissolved silicic acid or liquid silica sols may form which can be separated from the HPS and removed from the reaction chamber.

The base of the reaction chamber can, for example, be constructed as a funnel with sealable discharge orifice to discharge the solid or liquid reaction products. Moreover, for example, a false bottom with holes smaller than the diameter of the HPS beads or pellets used, can be provided to keep the HPS in the reaction chamber, while water and substances possibly dissolved therein can be removed. In this way, silicic acid products such as, for example, silicic acid can be washed out of the reaction chamber simply with aqueous, optionally, alkaline solution or as solid sedimented reaction products can be removed mechanically.

The reaction chamber may contain metal catalysts.

Instead of the bases or alkalis or additionally to the addition of bases or alkalis, catalysts can also he used to speed up the reaction. For example, metal catalysts of the transition metal oxides ma be considered. They can be used alone or as mixed oxides with other transition metals. Effective active components are, for example, iron, copper or chromium oxides. The catalysts can be arranged as a fixed structure in the reaction chamber or can be supplied from outside as required.

The supply device may have a waste heat recuperator which utilizes heat released during the reaction.

The waste heat released in the reaction chamber during the exothermic hydrolysis of HPS can, for example, be utilized by a heat exchanger or other heat recovery devices. The reaction chamber can be jacketed.

The supply device may have a water storage tank to supply water to the feed device.

With a delivery device such as a pump, water can be transported from the water storage tank into the reaction chamber. In addition, an inlet valve can be provided on the feed device to the reaction chamber. In this way, water necessary for the reaction can be supplied as required. In this water storage tank, by suitable addition of for example, sodium hydroxide solution, an alkaline aqueous solution can be prepared prior to feeding into the reaction chamber.

The feed device may be designed to condense and feed of water to the reaction chamber or to the water storage tank, wherein the water (or the steam which then condenses) is formed as reaction water in the fuel cell.

Fuel cells based on hydrogen and oxygen use oxygen as an oxidant in an H⁺-ion-conducting fuel cell. The overall reaction taking place in a hydrogen-oxygen fuel cell is the synthesis of water from hydrogen and oxygen:

2 H₂+O₂→2 H₂O

In this way, both electrical energy and water can he obtained which can be led away via the feed device. In this feed device, the water can condense out and supplied directly as a reactant in liquid form to the reaction chamber. In this way, the water that forms in the fuel cell can he returned both as gas and as liquid to the reaction chamber and reused,

Especially for use in aircraft, this is of advantage, as less water needs to be stored and a weight saving can be made.

The discharge device may have a pressure vessel with an inlet valve and an outlet valve for the intermediate storage of the hydrogen produced.

In this way, hydrogen that reacted during the reaction in the reaction chamber can be collected for temporary storage. Via the outlet valve, the hydrogen can be introduced into the fuel cell as required and electric current can be generated immediately. The pressure vessel used can be a standardized vessel which has a protected valve device to control in and out flow of the hydrogen gas. The valves can be controlled centrally by a control device and are automatically in a closed position if power outages or interruptions occur. In this way, uncontrolled further feed of hydrogen gas into the fuel cell or a possible hydrogen loss can be prevented.

The discharge device may have a hydrogen measuring device designed to measure the quality and/or quantity, especially flow or pressure, of the hydrogen produced.

In this way, the level of purity and the amount and/or pressure of the hydrogen produced can be verified. The hydrogen measuring device can be arranged directly in the discharge device or in a hydrogen branch line. If the measuring device is arranged in a bypass line, the quantity and the quality of the hydrogen can be checked continuously or with random sampling. The amount required for hydrogen measurement can either be fed back into the discharge device or can be led to the outside. A suitable measuring device is, for example, a gas chromatograph which can detect the purity of the hydrogen very accurately and quantify the amount of hydrogen.

If a gas chromatograph is used as the measuring device, a carrier gas is supplied and transported onto a suitable separating column. In this way the gas being, measured can be separated, wherein at the end of the column there is a detector which produces an electronic signal when a substance leaves the separating system. The electronic signal can then be recorded as a so-called “peak” on a suitable instrument and analyzed, and gas components detected can be determined very accurately qualitatively and quantitatively. The measuring signals are sent to a computer system with appropriate evaluation software. As carrier gases, for example, nitrogen are used in gas chromatography. In this measuring arrangement, it is not envisaged to return the measurement gas to the discharge device that leads to the fuel cell.

Furthermore, other hydrogen measuring devices can be used, fur example, measuring sensors or selective electrodes which in contrast to a gas chromatograph can continuously detect the hydrogen content or other trace gases relevant for monitoring.

The reaction in the reaction chamber can be controlled in relation to the measurement results of the hydrogen measuring device. If a marked decrease in quality of the purity of the hydrogen is measured, the outlet valve of the hydrogen intermediate storage can be controlled to stop the feed of hydrogen gas into the fuel cell. After optimal reaction conditions have been restored so that the level of purity is sufficient for operation in the fuel cell, the contaminated hydrogen gas can be removed from the system by replacing the pressure vessel, and pure hydrogen gas can be stored again in an empty pressure vessel.

The discharge device may have a separating device for residual steam and/or aerosols in the hydrogen gas.

Because heat is generated during the exothermic hydrolysis, it is possible for steam and/or aerosols to form unintentionally. To ensure purity of the hydrogen gas, any residual steam can be separated from the hydrogen gas by a separating device or by drying. Drying can, for example, also be coupled in the reaction chamber by the heat generated in the exothermic reaction. Furthermore, entrained aerosols, e.g. droplets of base which may pose problems for the fuel cell can be separated. For separating, it is possible, for example, to use particulate adsorbents or drying agents based on inorganic oxides such as silicon dioxide (silica gel), aluminum oxide or aluminum silicate.

The supply device may have a control device, which controls the amount of hydrogen produced by the amount of water added.

By controlling the amount of water added from outside, the amount of hydrogen produced can be controlled. The heat arising during the reaction can be controlled by controlling the addition of water. If the HPS is put in the reaction chamber, reaction parameters such as reaction rate can be controlled by dosage of a defined amount of aqueous solution or also by adjusting the pH in different steps. The reaction products, for example, silicic acid, can then be washed out by adding further alkaline solution and led away by a suitable discharge device for liquids. Level sensors can, for example, ensure that the amount of liquid in the reaction chamber does not exceed a specified required value.

Alternatively, the reaction chamber can be designed so that a basic, especially alkaline aqueous solution is already present and the reaction to hydrogen is controlled by adding solid HPS. Delivery devices to convey solid materials, for example, bucket wheels, are suitable for this. Moreover, the reactor itself can also be movable for mixing and can, for example, be constructed as a tilting reactor to ensure thorough mixing of the aqueous solution with the HPS. The aqueous solution used for reaction of the HPS consists either of pure water or of water with additives such as bases or alkalis or suitable catalysts. Additionally, the reaction heat released can be regulated by controlled addition of the additives.

If the water produced in the fuel cell is intended to be recycled, generally the amount of water in temporary storage can be reduced, as the wastewater arising during operation of the fuel cell can also be used for hydrolysis of the HPS. The amount of aqueous solution or of basic or alkaline aqueous solution stored can already be controlled in the water storage tank by the control device. The control device can also be designed so that after measurement of the pH in the water storage tank, it is adjusted to a specified required pH (e.g. pH=10) and it is only after attainment of the set value that the basic solution is led into the reaction chamber by the pump controls.

Furthermore, sensors can also be arranged in the reaction chamber to measure pH measurements, valve positions, levels or heat generated. Based on the measured parameters, the amount of water to he added or if the aqueous solution is already present, the amount of HPS or of additives to be added, can be monitored and controlled.

The fuel cell supply device may be used as a hydrogen supply of fuel cells in an aircraft.

HPS that consists of silicon-hydrogen compounds and possesses an average chain length with more than ten silicon atoms is no longer spontaneously flammable and can therefore be used in particular for mobile applications such as in aviation. These hydrogenated polysilanes can be handled and stored simply. The combination with a fuel cell and this hydrogen energy carrier is advantageous, as the water formed in the fuel cell can be reused in the reaction chamber. In this way, weight and cost savings can be made in an aircraft.

The fuel cell supply device that supplies hydrogen to fuel cells may be used as an emergency system in an aircraft.

In this application, the fuel cell supply device is designed as an emergency system. In this way, even with a power outage on board an aircraft, it can be ensured that production of hydrogen and operation of the fuel cell is ensured. For this, the valves are designed so that in the case of a power outage, they assume the position such that operation of the fuel cell supply device is maintained. Moreover, the HPS fuel cell supply device can be designed so that it is only activated in an emergency. In this way, especially in a power outage of the standard power supply systems, the power supply with HPS can be ensured, for example, for important systems of the aircraft.

An aircraft may be provided with a fuel cell supply device.

The silicic acid products Ruined along with water in the reaction of HPS are harmless to the environment and can easily be stored and disposed of.

Pure hydrogen that forms can be used, especially in aviation, for PEM fuel cells, in this way, with a single reaction step and coupling to a fuel cell, electrical energy can be obtained very quickly. Furthermore, a proportion of the heat released from the reactor can be used advantageously, for example, by feeding it to a heat exchanger. In this way, the heat can be recovered and/or used repeatedly. If the fuel cell is also equipped with a waste heat recuperator, it is possible for the two waste heat recuperators to be coupled together.

A method may be provided to produce hydrogen for fuel cells in an aircraft, with the following process steps: feeding at least one first or second reactant via a reaction chamber, wherein the first reactant comprises hydrogenated polysilane or mixtures thereof and the second reactant is water, reacting the first reactant with the second reactant in the reaction chamber and leading away the hydrogen that forms in the reaction to a fuel cell of the aircraft.

In this way, hydrogen can be produced with water simply in a reaction chamber from a hydrogen energy carrier that is easy to handle. The resultant pure gas can be led away to a fuel cell, where it can ensure operation of the fuel cell.

In the reaction chamber, hydrogen is cleaved from the hydrogenated polysilanes by hydrolysis. Hydrogenated polysilanes with a chain length of at least eleven to thirteen silicon atoms (Siₙh₂ₙ₊₂ and/or SiₙH₂ₙ; n>10 and n>12 respectively), as is known from DE 10 2006 043 929 A1, are solid under standard conditions and can be stored easily. The solid HPS can be put in the reaction chamber and an aqueous solution can be supplied.

From the standpoint of safety, the use of HPS as a starting material is advantageous, as this solid can be stored easily and fed to the reaction chamber. The high volume-specific energy density of the long-chain energy carriers is a particular advantage especially in the mobile area in aerospace applications. A high energy density means that the tank volume and therefore also the tank weight can be kept low and therefore cost savings can be made. In this way, more useful load, in particular, more cargo or passengers can be transported in the aircraft.

As polysilanes with chain lengths greater than six can be held at standard temperature with exclusion of air for a very long time without change, they are very suitable as energy carriers fur use in aviation. HPS can also be in the form of a mixture of hydrogenated polysilanes and/or a mixture of their constitutional isomers, for example, of an undecasilane Si₁₁H₂₃ with higher polysilanes such as, for example, a pentadecasilane Si₁₅H₃₂. Because it is solid, HPS can easily be kept in temporary storage or can be put in the reaction chamber. After reaction of HPS in the reaction chamber with an aqueous alkaline solution, hydrogen can be released and silicic acid products are formed. The solid or liquid reaction products can be separated continuously or discontinuously from the reaction chamber. To separate the solids, a suitable shape, e.g. a funnel shape of the reaction vessel can serve to collect and separate solids that form. The hydrogen gas that has formed can be led away to the fuel cell directly or indirectly via an intermediate storage tank.

The method may also have the following steps: adjusting the process water to a basic pH, reacting the hydrogenated polysilanes in the presence of metal catalysts, intermediate storage of the hydrogen produced in a pressure vessel, monitoring the purity and/or amount of hydrogen produced with a hydrogen measuring device and controlling the amount of hydrogen produced by the amount of water added.

The aqueous solution in the reaction chamber is adjusted to a pH above 7 to speed up the subsequent hydrolysis. Adjusting the process water to a basic pH can take place either in the reaction chamber itself or in the water storage tank by adding, for example, sodium hydroxide solution or potassium hydroxide solution. A pH of about 10 can be set to sufficiently speed up the reaction.

In addition to or instead of carrying out hydrolysis under basic conditions, the reaction can be accelerated by adding further or different catalysts. The catalysts can be transition metal oxides. As heat is released in the hydrolysis reaction, it may also happen that steam is formed. This can be removed before leading the hydrogen away to the fuel cell, for example, by drying with a suitable separator or drying agent. A separator can also separate entrained aerosols of bases. In this way, very pure hydrogen can be made available for the fuel cell. The hydrogen produced can be stored temporarily in a suitable pressure vessel, which has controllable inlet and outlet valves.

Furthermore, the quality and/or quantity of hydrogen produced can be controlled by interposing a hydrogen measuring device. A suitable measuring device to measure hydrogen is, for example, a gas chromatograph. Hydrogen gas can be led away to this gas chromatograph and then, by adding a carrier gas, can be measured by a separating column. Evaluation is then carried out by a suitable evaluating device, for example, a computer which determines the amount of hydrogen gas measured by the measured signals, especially the areas under the peaks. This measuring device can on the one hand verify the purity, and if there are impurities, supply of hydrogen gas to the fuel cell can be halted. On the other hand, it is also possible to connect quantitative hydrogen measurements to the control system of the reaction chamber, for example, to be able to supply the amount of hydrogen required in the fuel cell.

The amount of hydrogen produced can be controlled, for example, with the amount of water added. The amount of water can be added from outside with a pump supplying water into the reaction chamber as required. Furthermore, water can be led directly from the fuel cell into the reaction chamber. In this way the water can be reused. Moreover, the amount of hydrogen produced can also be controlled with the pH-setting or by adding basic, preferably alkaline, solution. Addition of basic solution can take place both in the reaction chamber itself and in the water storage tank. In this reaction process, only pure HPS and water or basic aqueous solution are used in the reaction chamber. Therefore, essentially pure hydrogen gas is formed which is suitable in particular for PEM fuel cells.

Moreover, it should be pointed out that the above features and process steps can also be combined. Combining the above process steps or features can lead to mutual effects and actions, which go beyond the individual effects of the corresponding features, even if this is not expressly described in detail.

Turning now to the Drawings, depictions in the Drawings are schematic and not to scale. Moreover, in the following description, the same reference symbols are used for the same or similar elements.

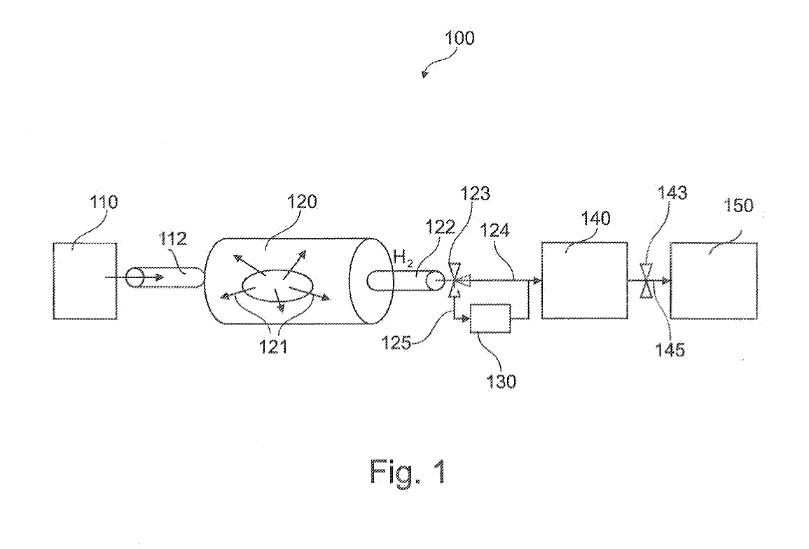

FIG. 1 shows a schematic representation of a fuel cell supply device 100 with a water storage tank 110, a reaction chamber 120 and a fuel cell 150. Furthermore, FIG. 1 shows a feed device 112 that supplies reactant water which can be stored temporarily in the water storage tank 110.

Furthermore, the reaction chamber has a discharge device 122-124, which can be used to lead away hydrogen that forms in the reaction to the fuel cell 150. This discharge device also comprises a valve 123 and a feed line from the valve 123 to an intermediate storage tank 140 in which the hydrogen gas can be stored temporarily and conveyed via an outlet valve 143 to the fuel cell via line 145. The intermediate storage tank for hydrogen can be constructed as a pressure vessel 140 with inlet valves and outlet valves 123 and 143, respectively, which are protected against shutoff. Furthermore, a drying device or separator 122 can be installed in the discharge device 122, 123, 124, for example, to dry or separate residual steam which may be formed in the exothermic reaction (arrows 121). If the heat released in the hydrolysis reaction is not required or there is too little, alternatively, insulation of the reaction chamber can be provided.

FIG. 1 also shows a discharge device 122-124 with a hydrogen branch line 125. This hydrogen branch line can be connected as a bypass to determine the amount, pressure and/or level of purity of the hydrogen with a suitable measuring device 130.

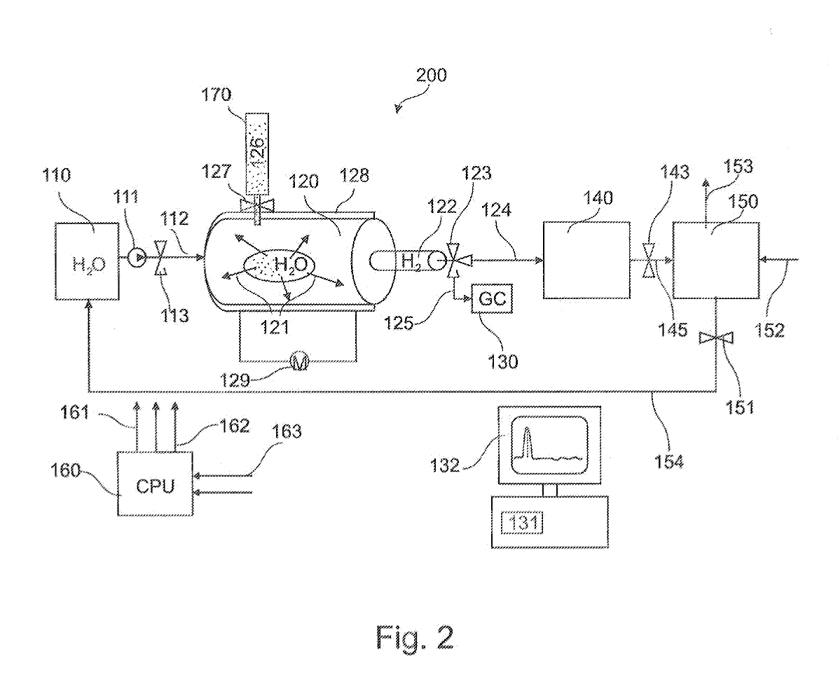

FIG. 2 shows another example of a fuel call supply device 200 with a water storage tank 110, a reaction chamber 120, a pressure vessel for the hydrogen obtained 140 and a fuel cell 150. In this case, advantageously, heat released in the conversion to hydrogen shown schematically by the arrows 121 is stored with a suitable device such as a reaction chamber jacket 128. The heat obtained can be reused, for example, by a heat exchanger 129. This waste heat recuperator 129 can also be coupled to the other heat recovery devices which are, for example, arranged near the fuel cell 150 or on a reaction chamber connected in parallel (not shown).

Furthermore, FIG. 2 shows schematically, for the reaction chamber, feed of hydrogenated polysilane 126 in the form of beads. The HPS 126 can be fed as required into the reaction chamber via an opening 127. The opening can be resealable and the storage tank 170 for the HPS 126 can be housed separately in another room. After feed of the HPS 126 into the reaction chamber 120, it can be collected, for example, in a collecting vessel constructed, for example, from a grating (indicated by the ellipse in FIG. 1), which preferably consists of catalytically active metal oxides, where it can be brought together with water. If no collecting vessels or false bottoms are provided, the initially insoluble HPS can be distributed throughout the aqueous solution by a recirculating pump (not shown).

Along with hydrogen, the further reaction gas oxygen or air, which in the course of the reaction taking place in the fuel cells after generation of electrical energy reacts to form water, is introduced into the fuel cell 150 via line 152. The fuel cell 150 is, for example, of the PEM type, wherein oxygen or air containing oxygen is supplied as all oxidant via line 152, whereas the reductant is separated spatially by a membrane. This proton exchange membrane is permeable to H⁺-ions exclusively. The energy obtained or the electricity generation (indicated by arrow 153) can be utilized immediately. The reaction product water formed in the fuel cell can be fed via the outlet valve 151 either in condensed form or in the form of steam into line 154 and then conveyed to the water storage tank 110. As an alternative to this arrangement, water obtained in the fuel cell can also be led directly into the reaction tank 120 (not shown).

In the discharge device arranged between the reaction chamber 120 and the pressure vessel 140 for temporary storage of hydrogen, there is once again a discharge device consisting of parts 122-124. In this example, a gas chromatograph 130 is used in the branch line 125 which operates with addition of a carrier gas to the quantity of hydrogen to be measured, and separation of the constituents of the gas mixture in a suitable separating column. At the end of the column, the amount of hydrogen present or other components of the mixture are detected and evaluated by a suitable computer system 131. The measured peaks can be indicated, for example, on the display 132, wherein the peak height and area under the peak determine the amount of hydrogen measured. With the evaluator 131, a very exact hydrogen measurement can be performed quantitatively and qualitatively. The evaluator 131 connects On the one hand to the gas chromatograph 130 and on the other hand to the control unit of the computer system 160 (connecting leads not shown in FIG. 1), for example, to send, measurement results via line 163 to the central computer unit 160 with a processor (CPU). Furthermore, the computer 160 has a storage unit which, for example, can store measured data such as flow rates, pressure or valve positions to be able to check the fuel cell supply device if faults develop.

Moreover, with the computer unit 160, valve 123 or valve 143 can be shut if poor quality of the hydrogen gas is detected. Furthermore, addition of water can be controlled by the computer unit 160 or the feed pump 111 can be adjusted depending on the need for water to transport water or optionally also basic solution from storage tank 110 via the feed device 112.

Moreover, further measuring devices can be arranged which send measured data to the control unit (for example, via arrow 163). For example, in the reaction chamber or water storage tank, the pH can be measured or the level can be sent to the control unit. Via line 161 and 162, the computer unit 160 can control various valves, pumps or other devices. Connections to the possible sensors or interfaces are not shown in FIG. 1.

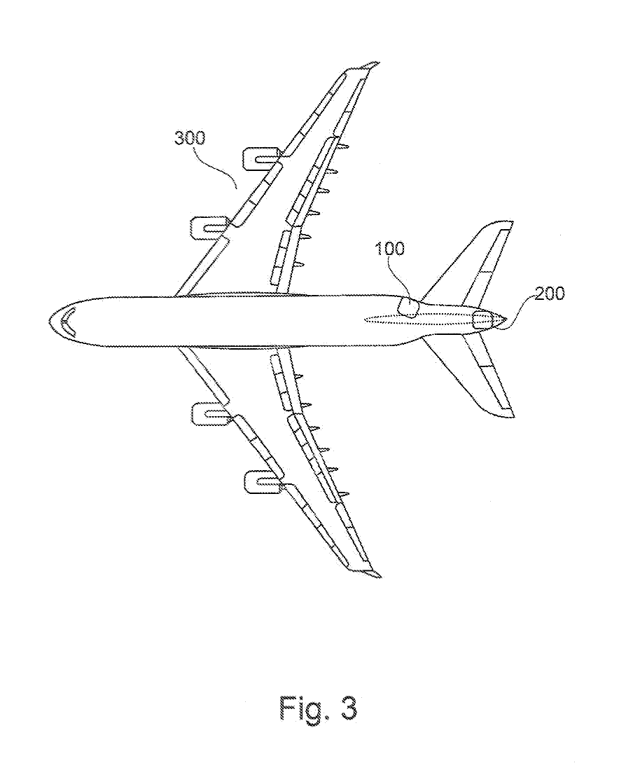

FIG. 3 shows a schematic view of an aircraft in which fuel cell supply devices 100 or 200 are used.

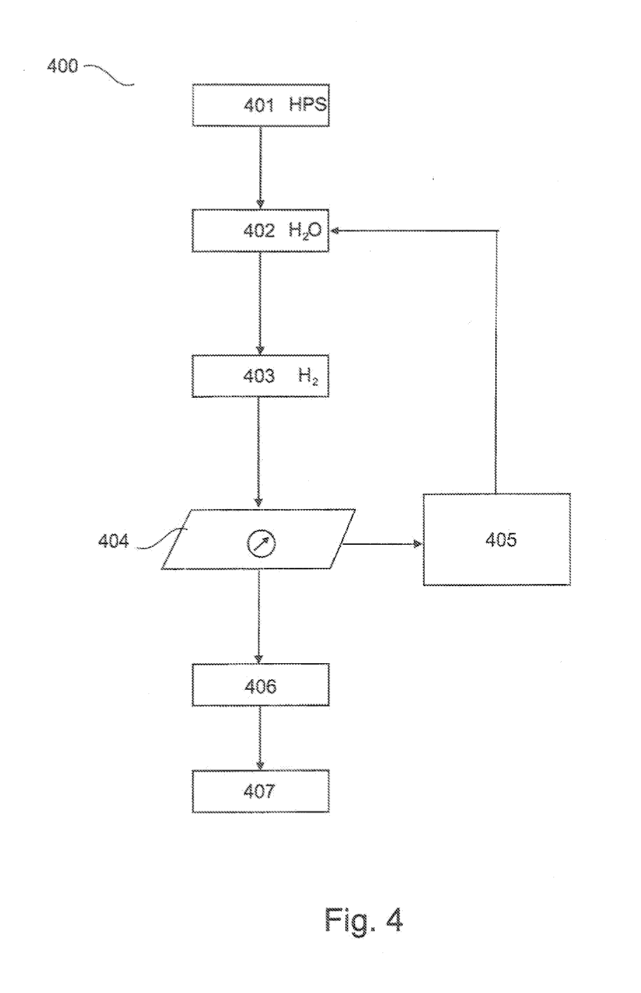

FIG. 4 shows a schematic view of a method for fuel cell supply with the following process steps: the method begins with step 401. In this step, a reaction chamber is provided in which possibly a reactant such as hydrogenated polysilane is prepared. As the next process step 402, at least one reactant is fed into the reaction chamber. If a second reactant is not yet present in the reaction chamber, this reactant is also supplied to the reaction chamber. In process step 403, the first reactant HPS reacts with the second reactant water.

During the reaction gaseous hydrogen forums. This hydrogen is measured in step 404 by a measuring device (hydrogen measuring device), for example, a gas chromatograph. In this way, purity of the hydrogen gas can be verified. Certain control parameters in the reaction chamber can be controlled depending on the measurement results. In process step 405, for example, control of the amount of hydrogen produced is represented by control of the amount of water added. Other control operations such as altering the pH or addition of catalysts are also possible.

In process step 406, the hydrogen produced is stored temporarily in a pressure vessel. The inlet and outlet valves of this pressure vessel can also he controlled depending on the level of purity of the process gas measured in process step 404. If the hydrogen is contaminated, the feed to the fuel cell can he stopped. Finally, in process step 407, the hydrogen produced in the reaction and stored temporarily in the pressure vessel is conveyed to a fuel cell, for example, of the PEM type.

It should be pointed out that the term “comprising” does not exclude further elements or process steps, just as the term “a” does not exclude several elements and steps. The reference symbols used serve only to increase comprehensibility and are definitely not to be regarded as limiting, and the scope of protection is defined by the appended claims.

1.-15. (canceled)

16. A fuel cell supply device that generates hydrogen for fuel cells in an aircraft comprising:
a reaction chamber which reacts hydrogenated polysilanes or mixtures thereof with water;
a feed device that feeds at least one reactant into the reaction chamber; and
a discharge device that leads hydrogen formed in the reaction to a fuel cell.

17. The fuel cell supply device according to claim 16, wherein hydrogenated polysilanes or mixtures thereof are present in a solid structure selected from the group consisting of powder, granules, beads, cubes, pellets and porous pieces.

18. The fuel cell supply device according to claim 16, wherein the reaction chamber provides a basic alkaline medium.

19. The fuel cell supply device according to claim 16, wherein the reaction chamber contains metal catalysts.

20. The Fuel cell supply device according to claim 16, further comprising a waste heat recuperator which utilizes heat released in the reaction.

21. The fuel cell supply device according to claim 16, further comprising a water storage tank that supplies water to the feed device.

22. The fuel cell supply device according to claim 16, wherein the feed device condenses and feeds in water to the water storage to and the water is formed as water of reaction in the fuel cell.

23. The fuel cell supply device according to claim 16, wherein the discharge device comprises a pressure vessel with an inlet valve and an outlet valve for intermediate storage of the hydrogen produced.

24. The fuel cell supply device according to claim 16, wherein the discharge device comprises a hydrogen measuring device that measures quality and/or quantity of the hydrogen produced.

25. The fuel cell supply device according to claim 16, wherein the discharge device comprises a separating device for residual steam and/or aerosols.

26. The fuel cell supply device according to claim 16, further comprising a control device that controls the amount of hydrogen produced by the amount of water added.

27. An aircraft comprising a fuel cell supply device according to claim 16.

28. A method of producing hydrogen for fuel cells in an aircraft comprising:
feeding at least one of a first and second reactant into a reaction chamber, wherein the first reactant comprises hydrogenated polysilanes or mixtures thereof and the second reactant is water;
reacting the first reactant with the second reactant in the reaction chamber; and
leading the hydrogen formed in the reaction to a fuel cell of the aircraft.
